(19) United States
(12) Patent Application Publication
(10) Pub. No.: US 2025/0079997 A1
(43) Pub. Date: Mar. 6, 2025

(54) Isolated Power Supply Having a Fast Output Response

(71) Applicant: National Taiwan University, Taipei (TW)

(72) Inventors: Yuan-Chih LIN, Taipei City (TW); Xiao-Ze LIN, Taipei City (TW); Ching-Jan CHEN, Taipei City (TW)

(21) Appl. No.: 18/617,701

(22) Filed: Mar. 27, 2024

(30) Foreign Application Priority Data
Sep. 1, 2023 (TW) 112133376

(51) Int. Cl. H02M 3/335; H02M 1/00

(52) U.S. Cl. CPC H02M 3/33523; H02M 1/0009

(57) ABSTRACT

The present invention provides an isolated power supply having a fast output response, comprising an isolated power supply and a control unit. The isolated power supply includes a primary side power-stage unit, a secondary side power-stage unit, and an isolation transformer, and the control unit includes a primary side control unit, a secondary side control unit, and a photo-coupling isolation unit.

### BACKGROUND OF THE INVENTION

### 1. Field of the Invention

The present invention relates to an isolated power supply, and more particularly, to an isolated power supply having a fast output response.

### 2. Description of the Prior Art

Please refer to FIG. 1A for an illustration of a conventional isolated power supply having a primary-side and a secondary-side control unit. Especially, FIG. 1A illustrates a conventional isolated power supply 100 having primary-side control unit and secondary-side control unit, which employs the internal loop control (current mode) as a commonly used control mode in the industry.

As shown in FIG. 1A, the isolated power supply 100 includes a primary-side power stage unit 110, a secondary-side power stage unit 120, and an isolation transformer 140. The input terminal of the primary-side of the isolated power supply 100 is connected to a DC voltage source VIN. The secondary-side output terminal of the isolated power supply 100 is connected to a load resistor R_{O}, to generate an output voltage VOUT and an output current IOUT. The primary-side power stage unit comprises switching elements and filtering circuits, while the secondary-side power stage unit includes rectifying elements and filtering circuits.

As shown in FIG. 1A, the isolation transformer 140 functions can transfer energy and provide electrical isolation between the primary side and the secondary side. The control unit 130 includes a primary-side control unit 132, a secondary-side control unit 134, and an optocoupler isolation unit 136. The primary-side control unit 132 comprises an internal loop (current mode) control unit and a pulse width modulation unit. The secondary-side control unit 134 serves as an external loop control unit 1342, responsible for output voltage regulation unit. The input terminal of the secondary-side control unit 134 receives a feedback signal V_{OSEN} from the output voltage, and the output terminal of the secondary-side control unit 134 outputs the optocoupler isolation unit input signal Vo. The input terminal of the primary-side control unit 132 receives the optocoupler isolation unit output signal V_{FB}, and the primary-side internal loop feedback signal V_{CSEN}. The output terminal of the primary-side control unit 132 outputs the primary-side switch control signal g. The optocoupler isolation unit 136 is used for electrical isolation and transmission of control signals from the secondary side to the primary side.

Please refer to FIG. 1B for an illustration of a conventional control scheme employing internal loop control (current mode). In the control architecture of FIG. 1A, a control method having internal loop control (current mode) is utilized in the primary-side control unit 132, which is a commonly used control mode in the industry. The secondary-side control unit 134 consists of an external loop control unit 1342, which serves as the output voltage regulation unit, incorporating a control circuit composed of components such as TL431 (a voltage regulator) or operational amplifiers.

Still referring to FIG. 1B, which depicts the conventional control scheme employing internal loop control (current mode) type, such as a series connection of the internal loop control unit 1322 (capable of receiving the optocoupler isolation unit output signal V_{FB}, and the primary-side internal loop feedback signal V_{CSEN}), and the external loop control unit 1342 (capable of receiving output voltage feedback signal V_{OSEN}, and reference voltage V_{REF}). The function of the external loop control unit 1342 (capable of outputting optocoupler isolation unit input signal V_{D}) is to adjust the transient response of the output voltage, and outputs a reference command to the internal loop control unit 1322 by the external loop control unit 1342. The role of the internal loop control unit 1322 is to improve and simplify the dynamic characteristics of the feedback control system, reducing the design complexity of the external loop control unit 1342. The internal loop control unit 1322 outputs a pulse width modulation control signal V_{M}, which is generated through a pulse width modulation generation unit 1324, generating the primary-side power stage switch control signal g as shown in FIG. 1B.

In the architecture of FIG. 1A, the transient response performance of the output voltage is primarily governed by the secondary-side control unit 134 (voltage regulation unit). Due to the operational characteristic limitations for the conventional power supply circuitry or control circuits, improper adjustment by the secondary-side control unit 134 may lead to slow response and an excessive voltage drop beyond specifications. As shown in FIG. 2A is the transient response diagram of the isolated power supply based on FIGS. 1A and 1B, or result in a faster response speed with oscillations, as illustrated in FIG. 2B for the transient response diagram of the isolated power supply based on FIGS. 1A and 1B.

Based on the foregoing explanations, developing a solution that effectively enhances the transient response speed of the output voltage would address the abovementioned shortcomings and ideally satisfy the identified needs.

### SUMMARY OF THE INVENTION

The present invention provides an “isolated power supply having a fast output response”, comprising an “isolated power supply”, and a “control unit”. The “isolated power supply” includes a “primary-side power stage unit”, a “secondary-side power stage unit”, and an “isolation transformer”. The “isolation transformer” serves as means for energy transfer and electrical isolation between the “primary-side power stage unit” and the “secondary-side power stage unit”. The output terminal of the “secondary-side power stage unit” is connected to a load resistor, to generate the output voltage and output current.

The present invention provides an “isolated power supply having a fast output response”, wherein the “control unit” includes a “primary-side control unit”, a “secondary-side control unit”, and an “optocoupler isolation unit”.

The present invention provides an “isolated power supply having a fast output response”, wherein the “optocoupler isolation unit” serves as electrical isolation, and as means for transmitting control signals from the “secondary-side control unit” to the “primary-side control unit”. The “secondary-side control unit” comprises an “output current feedforward compensation unit”, wherein the output terminal of the “output current feedforward compensation unit” outputting an “output current feedforward compensation unit output signal”. An “output current sensing unit” is connected to the output terminal of the “secondary-side power stage unit”, which generates an output current feedback signal based on the output current. The input terminal of the “output current feedforward compensation unit” receives the “output current feedback signal”, through the “output current feedforward compensation unit”, generating “output current feedforward compensation unit output signal”, and then the “output current feedforward compensation unit” outputs an “output current feedforward compensation unit output signal”, the “output current feedforward compensation unit output signal”, along with the “external loop control unit output voltage”, which is added to become as the “optocoupler isolation unit input signal”, and input into the “optocoupler isolation unit”. The “optocoupler isolation unit” outputs an “optocoupler isolation unit output signal”, which is transmitted to the “primary-side control unit”, serving as a reference command for “steady-state operation points” and “fast transient adjustment signals”. The “isolated power supply output voltage” achieves the fast transient response. Wherein, when the condition is under load shedding, the output voltage of the “isolated power supply” undergoes minimal transient response variations, so that the “optocoupler isolation unit” outputs “optocoupler isolation unit output signal” to have a fast transient response.

In an embodiment of the present invention, the “secondary-side control unit” includes an “external loop control unit”, the input terminal of the “secondary-side control unit” includes the “output voltage feedback signal”, and the output terminal of the “secondary-side control unit” includes the “external loop control unit output voltage”, “external loop control unit” adjusts the transient response of the output voltage, to achieve the fast transient response.

In an embodiment of the present invention, the “primary-side control unit” includes an “internal loop control unit” and a “pulse width modulation generation unit”. The input terminal of the “primary-side control unit” receives the “primary-side internal loop feedback signal”, and the “optocoupler isolation unit output signal”. The output terminal of the “primary-side control unit” outputs the “primary-side switch control signal”. When the condition is under load shedding, the output voltage of the “isolated power supply” undergoes minimal transient response variations, so that the “optocoupler isolation unit” outputs “optocoupler isolation unit output signal” having a fast transient response. The “primary-side internal loop feedback signal” follows the rapidly changing “optocoupler isolation unit output signal”, achieving the fast response adjustment.

In an embodiment of the present invention, the “optocoupler isolation unit output signal” is transmitted to the “internal loop control unit”, which outputs a “pulse width modulation control signal”. The “pulse width modulation control signal” is then sent to the “pulse width modulation generation unit”, to produce the “primary-side switch control signal”. The “optocoupler isolation unit output signal” provides a reference command for “steady-state operation points” and “fast transient adjustment” to the “primary-side control unit”. The “secondary-side control unit” provides the “primary-side control unit reference command” for the “fast transient adjustment signal”, enabling the output voltage of the “isolated power supply” to exhibit extremely the fast transient response.

In an embodiment of the present invention, the “primary-side power stage unit” comprises switching elements and filtering circuits.

In an embodiment of the present invention, the “secondary-side power stage unit” includes rectifying elements and filtering circuits. The output terminal of the “secondary-side power stage unit” is connected to a load resistor, to generate the output voltage and the output current, and the “secondary-side power stage unit” is in series with an “output current sensing circuit”.

In an embodiment of the present invention, the input terminal of the “primary-side power stage unit” is connected to a DC (direct current) voltage source.

In an embodiment of the present invention, the output voltage of the “external loop control unit” includes slow transient variation signals, and the “output current feedforward compensation unit output signal” provides the “steady-state operation point” and the “fast transient adjustment signals”.

In an embodiment of the present invention, there is also an “addition unit” connected between the “optocoupler isolation unit”, the “external loop control unit”, and the “output current feedforward compensation unit”. The “addition unit” is used to add the “output current feedforward compensation unit output signal”, and the “external loop control unit output signal” to form as the “optocoupler isolation unit input signal”.

The purpose of the present invention is to propose a method that uses the “output current feedforward compensation” to provide the “inner loop reference command steady-state operating point”, and the “fast transient adjustment”, so that the “voltage adjustment control unit (external loop control unit)” provides the “inner loop reference command slow transient adjustment signal”, through the aforementioned adjustment mechanism, enabling the “isolated power supply output voltage” to exhibit extremely the fast transient response behaviour.

For achieving the abovementioned purposes, characteristics and advantages of the invention can be understood much more obviously, the following embodiments and the Figures are attached for detailed description as follows, therefore, the advantages and features of the present invention will be further explained in detail with reference to the following examples and accompanying drawings for a deeper understanding.

### BRIEF DESCRIPTION OF THE DRAWINGS

The foregoing aspects and many of the attendant advantages of this invention will become more readily appreciated as the same becomes better understood by reference to the following detailed description, when taken in conjunction with the accompanying drawings, wherein:

FIG. 1A is for an illustration of a conventional isolated power supply having a primary-side and a secondary-side control unit.

FIG. 11B is for an illustration of a conventional control scheme employing internal loop control (current mode).

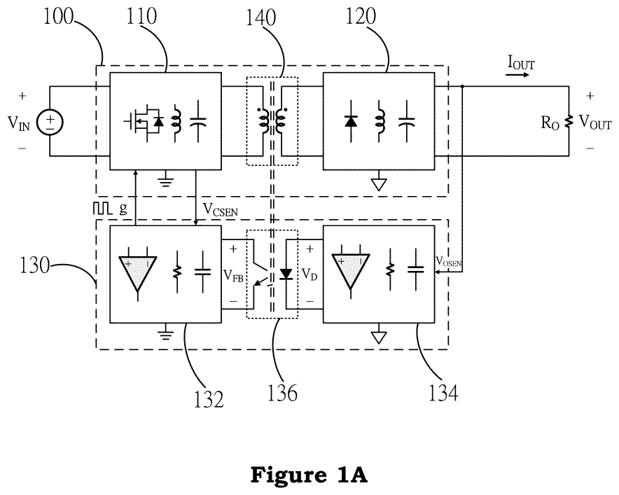

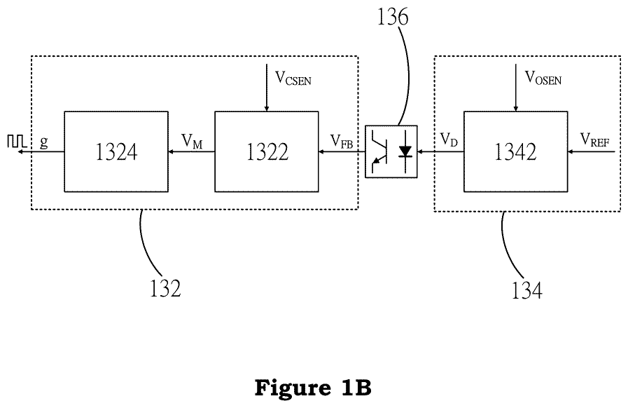

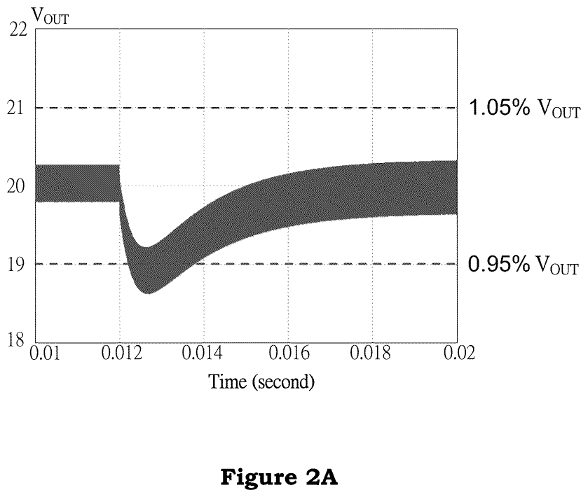

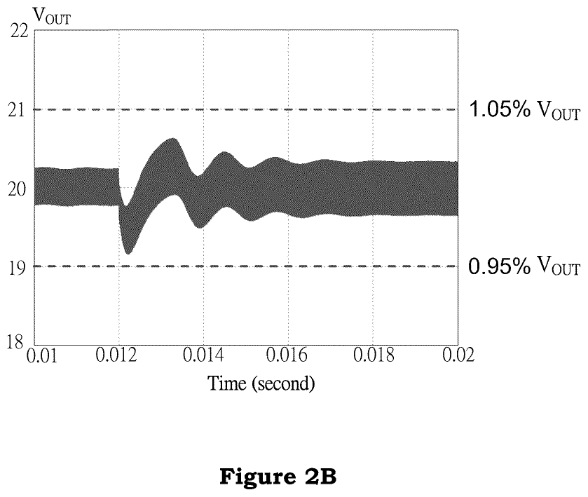

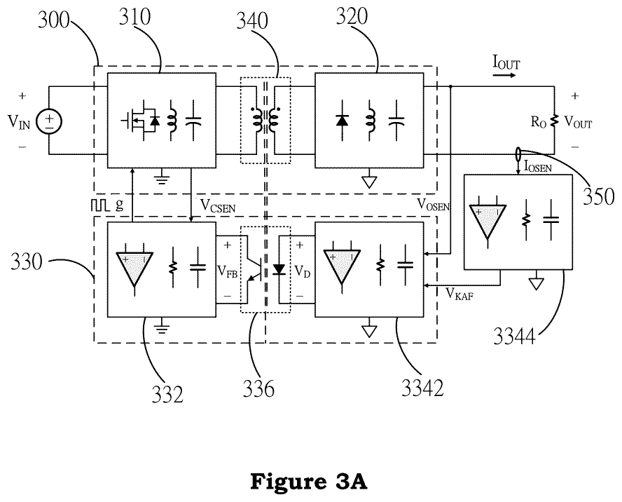

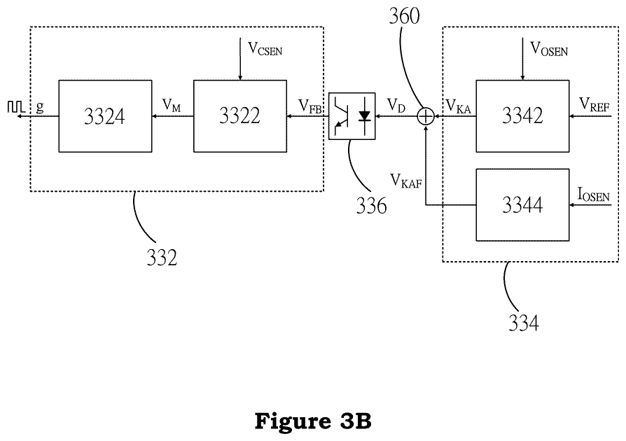

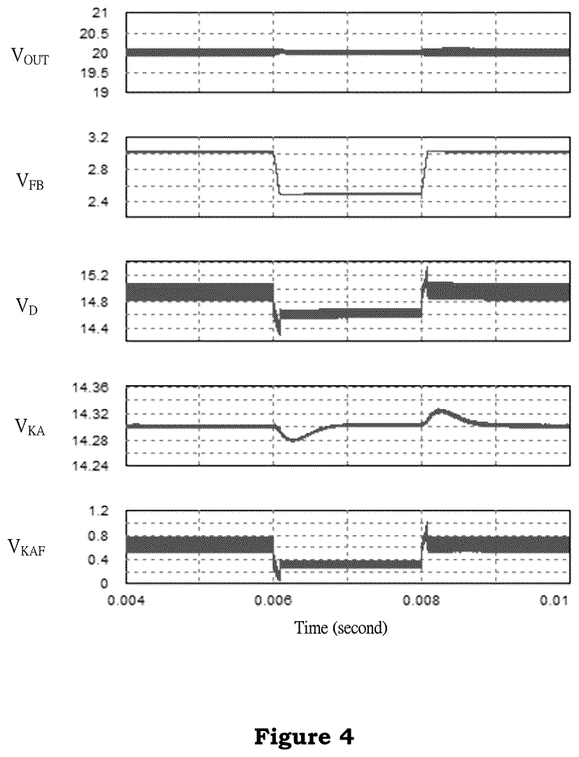

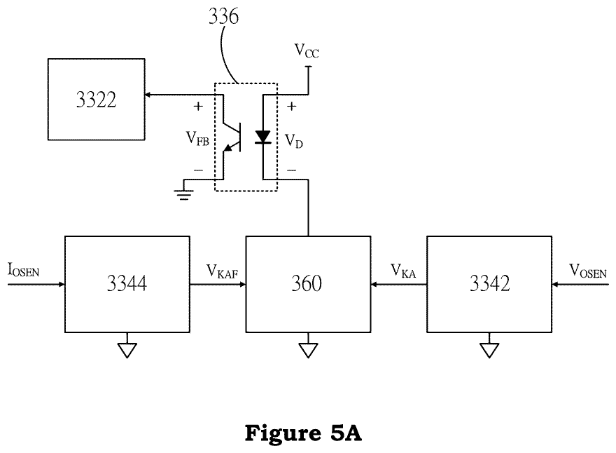

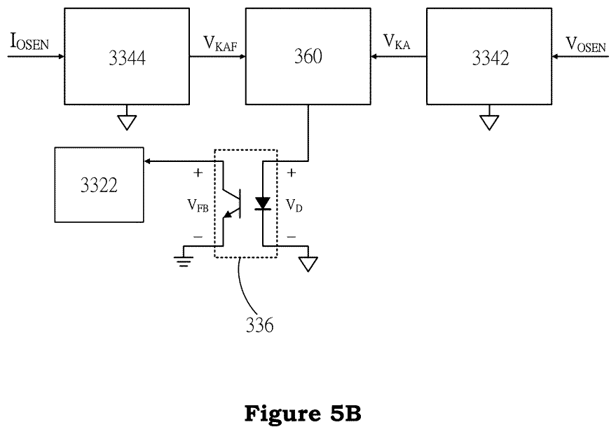

FIG. 2A shows the transient response diagram of the isolated power supply.

FIG. 2B presents the transient response diagram of the isolated power supply.

FIG. 3A illustrates an isolated power supply having fast output response of the present invention.

FIG. 3B presents a schematic diagram of “an internal loop control of secondary-side output current feedforward compensation”.

FIG. 4 shows the transient response waveforms simulated.

FIG. 5A illustrates the first embodiment of the secondary-side output current feedforward compensation of the present invention.

FIG. 5B illustrates the second embodiment of the secondary-side output current feedforward compensation of the present invention.

### DESCRIPTION OF THE PREFERRED EMBODIMENT

The following detailed description of the embodiments, in conjunction with the accompanying drawings, which serves to explain the present invention. However, the specific embodiments described are provided for illustrative purposes and are not intended to limit the scope of the present invention. The description of the structure and operation is not intended to limit the order of execution, and any device that achieves equivalent effects through the recombination of components is within the scope of the disclosed content.

Refer to FIG. 3A, which illustrates an isolated power supply 300 having the fast output response of the present invention. That is, the present invention provides an isolated power supply 300 having the fast output response, including a primary-side power stage unit 310, an isolation transformer 340, and a secondary-side power stage unit 320. The isolation transformer 340 enables energy transfer and electrical isolation between the primary-side power stage unit 310 (capable of outputting a primary-side inner-loop feedback signal V_{CSEN}) and the secondary-side power stage unit 320. The output terminal of the secondary-side power stage unit 320 is connected to a load resistor, to generate the output voltage and the output current.

Referring to FIG. 3B, which shows a schematic diagram of “an internal loop control of secondary-side output current feedforward compensation” based on the structure of FIG. 3A. Especially, FIG. 3B pertains to the control architecture of FIG. 3A, wherein, the control unit 330 includes a primary-side control unit 332, a secondary-side control unit 334, and an optocoupler isolation unit 336. The secondary-side control unit 334 comprises an “external loop control unit (i.e., output voltage adjustment unit, formed by a control circuit consisting of TL431 (voltage regulator) or an operational amplifier) 3342”, and a secondary-side output current feedforward compensation unit 3344.

Referring to FIG. 3A, showing an isolated power supply 300 having the fast output response of the present invention, the optocoupler isolation unit 336 serves as electrical isolation, and facilitates control signal transmission between the secondary-side control unit 334, and the primary-side control unit 332 (capable of outputting a primary-side switch control signal g). The secondary-side control unit 334 includes the secondary-side output current feedforward compensation unit 3344, the output terminal of the secondary-side output current feedforward compensation unit 3344 outputs the secondary-side output current feedforward compensation circuit output signal V_{KAF}.

Still referring to FIG. 3A, which is an isolated power supply 300 having the fast output response of the present invention, the output current sensing unit 350 is connected to the output terminal of the secondary-side power stage unit 320. The output current sensing unit 350 generates the output current feedback signal I_{OSEN} based on the output current IOUT, and the output current feedforward compensation circuit output signal V_{KAF}.

Continuing to refer to FIG. 3A, illustrating an isolated power supply 300 having the fast output response of the present invention, the input terminal of secondary-side output current feedforward compensation unit 3344 is the output current feedback signal I_{OSEN}. With the output current feedback signal I_{OSEN}, through the secondary-side output current feedforward compensation unit 3344, generates the output signal V_{KAF} of secondary-side output current feedforward compensation unit 3344. The secondary-side output current feedforward compensation unit 3344 outputs the secondary-side output current feedforward compensation unit output signal V_{KAF}, is added with the external loop control unit output voltage V_{KA} (FIG. 3B) to become as the optocoupler isolation unit input signal V_{D}, and then, inputting to the optocoupler isolation unit 336, and the optocoupler isolation unit 336 outputs the optocoupler isolation unit output signal V_{FB}, which is transmitted to the primary-side control unit 332. The optocoupler isolation unit output signal V_{FB} serves as a reference command for steady-state operation points and fast transient adjustment signals, enabling the isolated power supply output voltage VOUT to achieve the fast transient response. When the condition is under load shedding, the isolated power supply output voltage VOUT undergoes almost no more transient response changes, enabling the optocoupler isolation unit 336 to output the optocoupler isolation unit output signal V_{FB} to have the fast transient response.

Referring to FIG. 3B, showing a schematic diagram of internal loop control having secondary side output current feedforward compensation. The primary-side control unit 332 includes an inner loop control unit 3322, and a pulse width modulation generation unit 3324. The input terminal of the primary-side control unit 332 receives the primary-side inner-loop feedback signal V_{CSEN}, and the optocoupler isolation unit output signal V_{FB}. The output terminal of primary-side control unit 332 can output the primary-side switch control signal g. When the condition is under load shedding, the output voltage VOUT of the isolated power supply 300 (as shown in FIG. 3A) undergoes almost no more transient response changes, and then, enables the optocoupler isolation unit 336 to output the optocoupler isolation unit output signal V_{FB}, in order to have the fast transient response, and the primary-side inner-loop feedback signal V_{CSEN} can follow the rapidly changing optocoupler isolation unit output signal V_{FB}, thereby achieving the fast transient response adjustment.

Again, referring to FIG. 3B showing a schematic diagram of internal loop control having secondary side output current feedforward compensation. The optocoupler isolation unit output signal V_{FB} is transmitted to the inner loop control unit 3322, and then, generates the pulse width modulation control signal V_{M}. The pulse width modulation control signal V_{M} is transmitted to the pulse width modulation generation unit 3324, which generates the primary-side switch control signal g. The optocoupler isolation unit output signal V_{FB} is supplied to the primary-side control unit 332, to serve as a reference command for steady-state operation points and fast transient adjustment. The external loop control unit 3342 (with reference voltage V_{REF} input) provides the primary side control unit 332 with reference commands, to perform slow transient adjustment signals, so that the output voltage VOUT (FIG. 3A) of the isolated power supply 300 has a very high fast transient response. Furthermore, the primary-side control unit 332 includes the inner loop control unit 3322, and the pulse width modulation generation unit 3324, while the secondary-side control unit 334 includes the external loop control unit 3342, and the secondary-side output current feedforward compensation unit 3344.

FIG. 3A, illustrating an isolated power supply 300 having the fast output response of the present invention, the output terminal of the secondary-side power stage unit 320 is connected to a load resistor R_{O} to generate the output voltage VOUT, and the output current IOUT, which is connected in series with an output current sensing unit 350.

Still referring to FIG. 3A, illustrating an isolated power supply 300 having the fast output response of the present invention, the input of the primary-side power stage unit 310 is connected to a DC voltage source VIN. The loop control unit output voltage V_{KA} (FIG. 3B) contains the slow transient variation signal, and the “secondary-side output current feedforward compensation unit output signal V_{KAF}”, which can provide a steady-state operation point and fast transient adjustment signal.

Referring to FIG. 3B, which shows a schematic diagram of internal loop control having secondary side output current feedforward compensation, the secondary-side control unit 334 (as shown in FIG. 3B) includes an adder unit 360 connected between the optocoupler isolation unit 336, the external loop control unit 3342, and the secondary-side output current feedforward compensation unit 3344. The adder unit 360 is used to add the secondary-side output current feedforward compensation unit 3344, in order to output “secondary-side output current feedforward compensation unit output signal V_{KAF}”, and the output loop control unit output signal V_{KA} of the external loop control unit 3342, to become as the optocoupler isolation unit input signal Vo.

According to FIG. 3B, which shows a schematic diagram of internal loop control having secondary side output current feedforward compensation, the external loop control unit 3342 owns adjusting the transient response function of the output voltage VOUT (FIG. 3A) of the isolated power supply 300. The input terminal of the external loop control unit 3342 includes the output voltage feedback signal V_{OSEN}, and the output terminal contains the output voltage V_{KA} of the external loop control unit.

Referring to FIG. 3A, the operational principle for an isolated power supply 300 having fast output response of the present invention is as follows:

As shown in FIG. 3A, the output current sensing unit 350 generates the output current feedback signal I_{OSEN} based on the output current IOUT. After adjustment by the secondary-side output current feedforward compensation unit 3344 (as shown in FIG. 3B, with the input of the output current feedback signal I_{OSEN}), the output signal V_{KAF} from the secondary-side output current feedforward compensation unit 3344, which is added with the external loop control unit output signal, also, which is transmitted to the primary-side control unit 332 via the optocoupler isolation unit 336 to provide a reference command for the inner loop control unit 3322 (as shown in FIG. 3B). The inner loop control unit 3322 owns the function of improving and simplifying the dynamic characteristics of the feedback control system, effectively reducing the design complexity of the external loop control unit 3342. The output V_{M} of the inner loop control unit 3322 (as shown in FIG. 3B) is generated via the pulse-width modulation generation unit 3324, to generate the primary-side switch control signal g shown in FIG. 3A.

As shown in FIG. 3A, the secondary-side output current feedforward compensation unit 3344 provides the reference command for the inner loop control unit 3322 (as shown in FIG. 3B) for steady-state operation points and fast transient adjustments. The external loop control unit 3342 (which can receive the output voltage feedback signal V_{OSEN}) provides the inner loop reference command for slow transient adjustment signal. Through the abovementioned adjustment mechanism, the output voltage VOUT of isolated power supply 300 can achieve the very fast transient response.

Please refer to FIG. 4, which shows the transient response waveforms simulated according to FIG. 3A and FIG. 3B of the present invention. Based on the simulation results of FIG. 4 corresponding to FIGS. 3A, and FIG. 3B, under full load condition to 6 milliseconds (ms), when the load is switched to half load operation to 8 milliseconds (ms), and then, the load is switched back to full load operation. As shown in FIG. 4, when the condition is under load shedding, the optocoupler isolation unit output signal V_{FB} quickly reaches the steady state at different load switching times, causing almost no more transient changes in the output voltage VOUT of the isolated power supply 300.

In FIG. 4, V_{D}=V_{KA}+V_{KAF} (corresponding to FIG. 3B).

Furthermore, in FIG. 4, the external loop control unit output signal V_{KA} contains only slow transient variation signal. The secondary-side output current feedforward compensation circuit output signal V_{KAF} provides a steady-state operation point and a fast transient adjustment signal. By FIG. 4, when using the method of the present invention, there is a significant improvement to the transient response of the “isolated power supply output voltage”.

As FIG. 3B, which is illustrated based on FIG. 3A, FIG. 3B showing a schematic diagram of “internal loop control having secondary side output current feedforward compensation”, the present invention enumerates two voltage regulation units (i.e., external loop control units 3342), and adds examples for the output current feedforward compensation unit. The secondary-side output current feedforward compensation unit includes a feedforward compensation network for adjusting the output voltage transient response. The adder unit 360 adds the secondary-side output current feedforward compensation unit output signal V_{KAF}, and the external loop control unit output signal V_{KA}, and then, transmits through the optocoupler isolation unit 336 to the primary side as an inner loop reference command.

FIG. 5A is an illustration of the first embodiment of the secondary-side output current feedforward compensation of the present invention, and FIG. 5B is an illustration of the second embodiment of the secondary-side output current feedforward compensation of the present invention.

In the first embodiment, a bias voltage needs to be connected to the input terminal of the optocoupler isolation unit 336.

Referring to FIG. 5A, the input terminal of the external loop control unit 3342 receives the output voltage feedback signal V_{OSEN}, and the output terminal outputs the external loop control unit output signal V_{KA}.

Still referring to FIG. 5A, the input terminal of the secondary-side output current feedforward compensation unit 3344 receives the output current feedback signal I_{OSEN}, and the output terminal outputs the secondary-side output current feedforward compensation unit output signal V_{KAF}.

Continuing to refer to FIG. 5A, the external loop control unit output signal V_{KA}, and the of the secondary-side output current feedforward compensation unit output signal V_{KAF} are added by the adder unit 360, to generate the optocoupler isolation unit input signal Vo. The optocoupler isolation unit output signal V_{FB} is from the optocoupler isolation unit input signal V_{D} generated by the optocoupler isolation unit 336. The optocoupler isolation unit output signal V_{FB} is transmitted to the inner loop control unit 3322 as the reference command. The secondary-side bias voltage V_{CC} serves as the power supply for the input terminal of the optocoupler isolation unit 336.

In the second embodiment, there is no need to connect a bias voltage to the input terminal of the optocoupler isolation unit 336.

Referring to FIG. 5B, the input terminal of the output voltage adjustment unit (i.e., external loop control unit 3342) receives the output voltage feedback signal V_{OSEN}, and the output terminal outputs the external loop control unit output signal V_{KA}. The input terminal of the secondary-side output current feedforward compensation unit 3344 receives the output current feedback signal I_{OSEN}, and the output terminal outputs the secondary-side output current feedforward compensation unit output signal V_{KAF}.

Referring to FIG. 5B, the external loop control unit output signal V_{KA} and the secondary-side output current feedforward compensation unit output signal V_{KAF} are added by the adder unit 360, to generate the optocoupler isolation unit input signal Vo. Here, the optocoupler isolation unit output signal V_{FB} that is from the optocoupler isolation unit input signal V_{D} generated by the optocoupler isolation unit 336. The optocoupler isolation unit output signal V_{FB} is transmitted to the inner loop control unit 3322 as a reference command.

It is understood that various other modifications will be apparent to and can be readily made by those skilled in the art without departing from the scope and spirit of the invention. Accordingly, it is not intended that the scope of the claims appended hereto be limited to the description as set forth herein, but rather that the claims be construed as encompassing all the features of patentable novelty that reside in the present invention, including all features that would be treated as equivalents thereof by those skilled in the art to which the invention pertains.

What is claimed is:

1. An isolated power supply unit having fast output response, comprising:
a primary-side power stage unit, an input terminal of said primary-side power stage unit being connected to a DC voltage source;
a secondary-side power stage unit, an output terminal of said secondary-side power stage unit being connected to a load resistor to generate an output voltage and an output current;
an isolation transformer as an energy transfer and an electrical isolation between said primary-side power stage unit to said secondary-side power stage unit;
a control unit, comprising:
a primary-side control unit;
a secondary-side control unit, said secondary-side control unit including an output current feedforward unit, an input terminal of said output current feedforward compensation unit comprising an output current feedback signal, an output terminal of said output current feedforward compensation unit comprising an output current feedforward compensation unit output signal;
an opto-isolation unit, said opto-isolation unit serving as said electrical isolation and transmitting a control signal between from said secondary-side control unit to said primary-side control unit;
an output current sensing unit, said output current sensing unit being connected to said output terminal of said secondary-side power stage unit, generating an output current feedback signal based on an output current;
said output current feedforward compensation unit, an input terminal of said output current feedforward unit receiving an output current feedback signal by using an output current feedforward compensation unit output signal, via said output current feedforward compensation unit, generating said output current feedforward compensation unit output signal, said output current feedforward compensation unit outputting said output current feedforward compensation unit output signal, adding said output current feedforward compensation unit output signal with an outer loop control unit output voltage, to become an opto-isolation unit input signal, and inputting said opto-isolation unit, said opto-isolation unit outputting an opto-isolation unit output signal, transmitting to said primary-side control unit, to serve as a reference command for steady-state operation and transient adjustment, achieving a fast transient response of said isolated power supply,
wherein, when a condition being under load shedding, there is no more transient response variation for an output voltage of said isolated power supply, enabling said opto-isolation unit to output said opto-isolation unit output signal, generating said fast transient response.

2. The isolated power supply unit according to claim 1, wherein said secondary-side control unit comprises an outer loop control unit, an input terminal of said secondary-side control unit that receiving an output voltage feedback signal, and an output terminal of said secondary-side control unit that generating an outer loop control unit output signal, said outer loop control unit adjusts a transient response of an output voltage of an isolated power supply, enabling said output voltage of said isolated power supply to achieve said transient response.

3. The isolated power supply unit according to claim 1, wherein said primary-side control unit comprises an inner loop control unit and a pulse width modulation generation unit, an input terminal of said primary-side control unit receiving a primary-side inner loop feedback signal and an opto-isolation unit output signal, and an output terminal of said primary-side control unit outputting a primary-side switch control signal, when an condition being under load shedding, there is no more transient response variation of an output voltage of said isolated power supply, enabling said opto-isolation unit outputting said opto-isolation unit output signal having a fast transient response, said primary-side inner loop feedback signal following said opto-isolation unit output signal, achieving a fast response adjustment.

4. The isolated power supply unit according to claim 1, wherein said opto-isolation unit output signal being sent to said inner loop control unit, generating a pulse width modulation control signal, said pulse width modulation control signal being transmitted to a pulse width modulation generation unit, generating a primary-side switch control signal, said opto-isolation unit output signal being provided to said primary-side control unit as a reference command for steady-state operation and transient adjustment, and said outer loop control unit providing said primary-side control unit with a reference command transient adjustment signal, enables said output voltage having a transient response.

5. The isolated power supply unit according to claim 1, wherein said primary-side power stage unit comprises a switching element and a filtering circuit.

6. The isolated power supply unit according to claim 1, wherein said secondary-side power stage unit comprises a rectifying element and a filtering circuit.

7. The isolated power supply unit according to claim 1, wherein the output terminal of said secondary-side power stage unit is connected to a load resistor, to generate an output voltage and an output current, and being connected in series with an output current sensing circuit.

8. The isolated power supply unit according to claim 1, wherein said input terminal of said primary-side power stage unit is connected to a DC voltage source.

9. The isolated power supply unit according to claim 1, wherein said outer loop control unit output signal comprises a transient variation signal, said output current feedforward compensation unit output signal providing a steady-state operating point and a transient adjustment signal.

10. The isolated power supply unit according to claim 1, further comprising an adder unit, said adder unit being connected to said opto-isolation unit, said outer loop control unit, and said output current feedforward compensation unit, said adder unit is used to add said output current feedforward compensation unit output signal, and an outer loop control unit output signal to become said for said opto-isolation unit input signal.
